(19) United States
(12) Patent Application Publication
(10) Pub. No.: US 2025/0165956 A1
(43) Pub. Date: May 22, 2025

(54) System and Method of Defragmentation and Customized Optimization of Physical Assets Corresponding to Digital Tokens of a Distributed Ledger in a Decentralized Computing Environment

(71) Applicant: HSBC GLOBAL SERVICES (UK) LIMITED, London (GB)

(72) Inventor: Prashant Malik, London (GB)

(73) Assignee: HSBC GLOBAL SERVICES (UK) LIMITED, London (GB)

(21) Appl. No.: 18/517,422

(22) Filed: Nov. 22, 2023

(51) Int. Cl. G06Q 20/36

(52) U.S. Cl. CPC G06Q 20/367

(57) ABSTRACT

A computing system receives a plurality of transactions in a decentralized computing environment involving digital tokens backed by physical assets. The plurality of transactions spanning a first time period. The computing system identifies a previous position of the decentralized computing environment by capturing a snapshot of token ownership and physical asset to digital token allocation during a period immediately preceding the first time period. The computing system identifies inventory information corresponding to the physical assets backing the digital tokens. The computing system defragments an allocation of physical assets to digital tokens based on the plurality of transactions, the previous position of the decentralized computing environment, and the inventory information corresponding to the physical assets. The computing system broadcasts the plurality of transactions to a distributed ledger of the decentralized computing environment.

### FIELD OF THE DISCLOSURE

Embodiments disclosed herein generally relate to a system and method for defragmenting an allocation of physical assets to digital tokens of a distributed ledger in an asset-backed decentralized computing environment.

### BACKGROUND

Distributed ledger technology has become more commonplace as it allows for a given ledger to be spread across a plurality of devices across a plurality of locations. Rather than provide a single or centralized point of failure, the distributed ledger can be replicated across each device that acts as a host to the distributed ledger. As distributed ledger technology becomes more commonplace, so too are the computational demands of each host participating in the decentralized computing environment.

### SUMMARY

In some embodiments, a method is disclosed herein. A computing system receives a plurality of transactions in a decentralized computing environment involving digital tokens backed by physical assets. The plurality of transactions spans a first time period. The computing system identifies a previous position of the decentralized computing environment by capturing a snapshot of token ownership and physical asset to digital token allocation during a period immediately preceding the first time period. The computing system identifies inventory information corresponding to the physical assets backing the digital tokens. The computing system defragments an allocation of physical assets to digital tokens based on the plurality of transactions, the previous position of the decentralized computing environment, and the inventory information corresponding to the physical assets. Following the defragmenting, the computing system broadcasts the plurality of transactions to a distributed ledger of the decentralized computing environment.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a plurality of transactions in a decentralized computing environment involving digital tokens backed by physical assets. The plurality of transactions spans a first time period. The operations further include identifying, by the computing system, a previous position of the decentralized computing environment by capturing a snapshot of token ownership and physical asset to digital token allocation during a period immediately preceding the first time period. The operations further include identifying, by the computing system, inventory information corresponding to the physical assets backing the digital tokens. The operations further include defragmenting, by the computing system, an allocation of physical assets to digital tokens based on the plurality of transactions, the previous position of the decentralized computing environment, and the inventory information corresponding to the physical assets. The operations further include, following the defragmenting, broadcasting, by the computing system, the plurality of transactions to a distributed ledger of the decentralized computing environment.

In some embodiments, a system is disclosed herein. The system includes a processor and a memory. The memory has programming instructions stored thereon, which, when executed by the processor, causes the system to perform operations. The operations include receiving a plurality of transactions in a decentralized computing environment involving digital tokens backed by physical assets. The plurality of transactions spans a first time period. The operations further include identifying a previous position of the decentralized computing environment by capturing a snapshot of token ownership and physical asset to digital token allocation during a period immediately preceding the first time period. The operations further include identifying inventory information corresponding to the physical assets backing the digital tokens. The operations further include defragmenting an allocation of physical assets to digital tokens based on the plurality of transactions, the previous position of the decentralized computing environment, and the inventory information corresponding to the physical assets. The operations further include, following the defragmenting, broadcasting the plurality of transactions to a distributed ledger of the decentralized computing environment.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating off-chain processing platform, according to example embodiments.

FIG. 3 is a flow diagram illustrating a method of defragmenting an assignment of physical assets to digital assets, according to example embodiments.

FIG. 4A illustrates a system bus computing system architecture, according to example embodiments.

FIG. 4B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Distributed Ledger Technology (DLT) based systems are increasingly being used to enable Asset Tokenization. Tokenization may refer to a process of converting claims or ownership of an asset or a fraction of an asset into digital token(s) typically on a distributed ledger employing DLT techniques. Several use cases across industries require that these tokens represent legal claims on physical asset(s) and are backed by those asset(s). These tokens are called asset-backed tokens. Asset-backed tokens may be backed by assets ranging from those trading on traditional electronic trading markets such as precious metals to relatively illiquid assets such as real estate, sports and entertainment related artefacts etc.

In some embodiments, asset-backed tokens may be fungible tokens. When, for example, asset-backed tokens are fungible tokens, each token is assigned the same fractional share of a physical asset. In some embodiments, asset-backed tokens may be non-fungible tokens. When, for example, asset-backed tokens are non-fungible tokens, each token may be assigned a different fractional share of a physical asset of identification or unidentical characteristics.

One or more techniques described herein provide improvements to distributed ledger technology, focusing on the process of backing digital tokens issued on a distributed ledger with physical assets. In some embodiments, the backing of digital tokens may be performed utilizing one or more off-chain microservices that maps or attaches physical assets to digital tokens. Such digital tokens may then be broadcast or written to the distributed ledger technology or distributed ledger based distributed processing system.

As those skilled in the art understand, the trading of digital tokens, especially those backed by physical assets, can present several technical issues. One such technical issue takes the form of fragmentation. For example, because a digital token can be issued against or attached to a fraction of the backing physical asset, over time, repeat trading of the digital token may result in fragmentation, i.e., allocations of digital tokens may become scattered throughout multiple units of the physical assets, thus leaving unallocated fragments within individual units of the physical assets. Such fragmentation results in sub-optimal usage of the physical assets backing the digital tokens.

One or more techniques provided herein addresses the fragmentation issue by providing one or more off-chain microservices that optimizes the allocation of physical assets to digital tokens prior to broadcasting the digital token transaction to a distributed ledger (e.g., a blockchain). The micro-services may be executed off-chain to meet the computational demands of processing high transaction throughputs and reducing the processing requirements of such distributed systems.

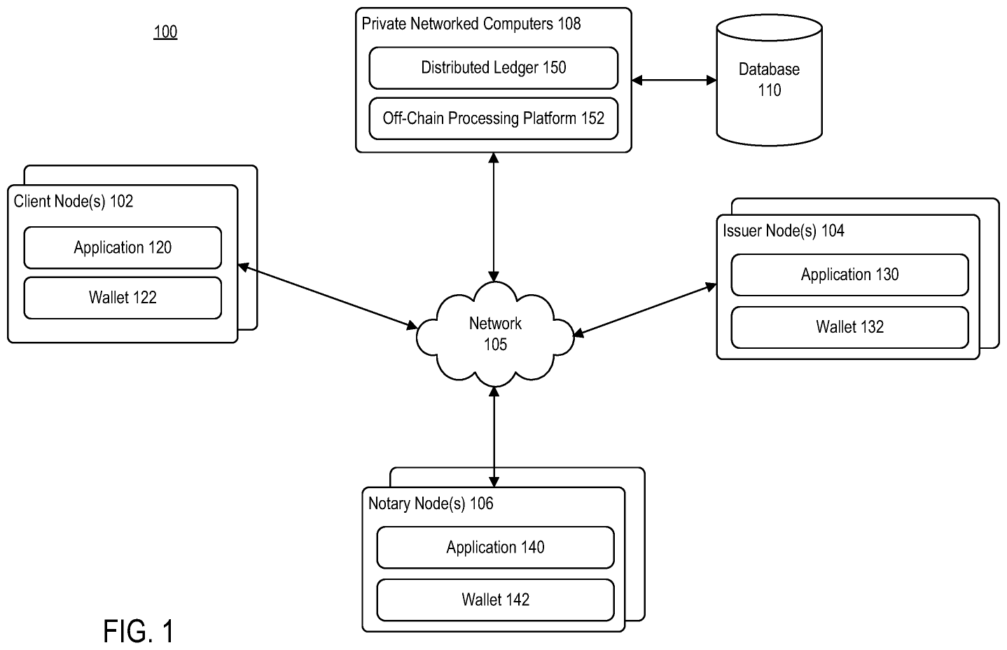

FIG. 1 is a block diagram illustrating a computing environment 100, according to one embodiment. Computing environment 100 may include at least a one or more client nodes 102 (e.g., client node 102), one or more issuer nodes 104 (e.g., issuer node 104), one or more notary nodes (e.g., notary node 106), and private networked computers 108 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receiving information between the components of computing environment 100.

Client nodes 102 may be representative of one or more client devices operated by users. For example, client nodes 102 may represent devices of users that buy, sell, or trade digital tokens backed by a physical asset. In some embodiments, client node 102 may be representative of one or more computing devices, such as, but not limited to, a mobile device, a tablet, a personal computer, a laptop, a desktop computer, or, more generally, any computing device or system having the capabilities described herein.

Client node 102 may include application 120 and wallet 122. Application 120 may be associated with at least off-chain processing platform 152 and/or issuer nodes 104. In some embodiments, application 120 may be a standalone application associated with at least private networked computers 108. In some embodiments, application 120 may be representative of a web-browser configured to communicate with private networked computers 108.

In some embodiments, client node 102 may be configured to execute application 120 to buy, sell, or trade asset backed tokens. The content that is displayed to the user via client node 102 may be transmitted from a web client application server of one of private networked computers 108 to client node 102, and subsequently processed by application 120 for display through a graphical user interface (GUI).

Wallet 122 may be configured to store a user's fungible tokens (e.g., cryptocurrency) and non-fungible tokens in an encrypted manner. In some embodiments, wallet 122 may be representative of a hot wallet, which is a cryptographic wallet connected to a network, such as network 105. In some embodiments, wallet 122 may be representative of a cold wallet, which is not connected to a network.

Issuer nodes 104 may be representative of an entity or organization that issues new digital tokens that are backed with physical assets. In some embodiments, issuer nodes 104 may be an entity or organization associated with private networked computers 108. For example, issuer nodes 104 may be associated with an entity or organization that supports private distributed ledger 150.

In some embodiments, issuer node 104 may be representative of one or more computing devices, such as, but not limited to, a mobile device, a tablet, a personal computer, a laptop, a desktop computer, or, more generally, any computing device or system having the capabilities described herein.

Issuer node 104 may include application 130 and wallet 132. Application 130 may be associated with at private networked computers 108. In some embodiments, application 130 may be a standalone application associated with at least one private networked computer 108. In some embodiments, application 130 may be representative of a web-browser configured to communicate with private networked computers 108.

In some embodiments, issuer node 104 may be configured to execute application 130 to buy, sell, or trade asset backed tokens. The content that is displayed to the user via issuer node 104 may be transmitted from a web client application server of one of private networked computers 108 to issuer node 104, and subsequently processed by application 130 for display through a graphical user interface (GUI).

Wallet 132 may be configured to store fungible tokens (e.g., cryptocurrency) and non-fungible tokens to be distributed to end users in an encrypted manner. In some embodiments, wallet 132 may be representative of a hot wallet, which is a cryptographic wallet connected to a network, such as network 105. In some embodiments, wallet 132 may be representative of a cold wallet, which is not connected to a network.

Notary nodes 106 may be representative of users that sign or validate transactions on distributed ledger 150. In some embodiments, notary node 106 may be representative of one or more computing devices, such as, but not limited to, a mobile device, a tablet, a personal computer, a laptop, a desktop computer, or, more generally, any computing device or system having the capabilities described herein.

Notary node 106 may include application 140 and wallet 142. Application 140 may be associated with at private networked computers 108. In some embodiments, application 140 may be a standalone application associated with at least one private networked computer 108. In some embodiments, application 140 may be representative of a web-browser configured to communicate with private networked computers 108.

In some embodiments, notary node 106 may be configured to execute application 140 to review, sign, and validate a distributed ledger transaction. For example, notary node 106 may be representative of a node that participates in a proof-of-work or proof-of-stake process to verify a distributed ledger transaction between two client nodes 102. The content that is displayed to the user via notary node 106 may be transmitted from a web client application server of one of private networked computers 108 to notary node 106, and subsequently processed by application 140 for display through a graphical user interface (GUI).

Wallet 142 may be configured to store fungible tokens (e.g., cryptocurrency) and non-fungible tokens to be distributed to end users in an encrypted manner. In some embodiments, wallet 142 may be representative of a hot wallet, which is a cryptographic wallet connected to a network, such as network 105. In some embodiments, wallet 142 may be representative of a cold wallet, which is not connected to a network.

Networked computers 108 may be configured to host distributed ledger 150. As shown, distributed ledger 150 is a private distributed ledger, such as, for example, a private distributed ledger associated with issuer nodes 104. Generally, distributed ledger 150 may be representative of any distributed ledger configured to support fungible tokens and non-fungible tokens. For example, distributed ledger 150 may be a private distributed ledger based on the Ethereum platform.

As shown, networked computers 108 may include off-chain processing platform 152. Off-chain processing platform 152 may be configured to optimize the tokenization process, such that the minimum possible number of physical assets are utilized in backing the overall digital tokens issued on distributed ledger 150.

In some embodiments, off-chain processing platform 152 may be co-located with database 110 and/or distributed ledger 150. For example, in some embodiments, off-chain processing platform 152 may be co-located with database 110, which may store a portion of distributed ledger 150. In some embodiments, database 110 may store a representation of data corresponding to distributed ledger 150. For example, database 110 may store a copy of ownership of digital tokens issued on distributed ledger 150, a record of transactions between participants to distributed ledger 150, and/or mappings between digital tokens and physical assets. In some embodiments, computing environment 100 may not include a database 110. In such embodiments, off-chain processing platform 152 may determine token-asset mappings and broadcast those token-asset mappings directly to distributed ledger 150, without storing an off-chain copy.

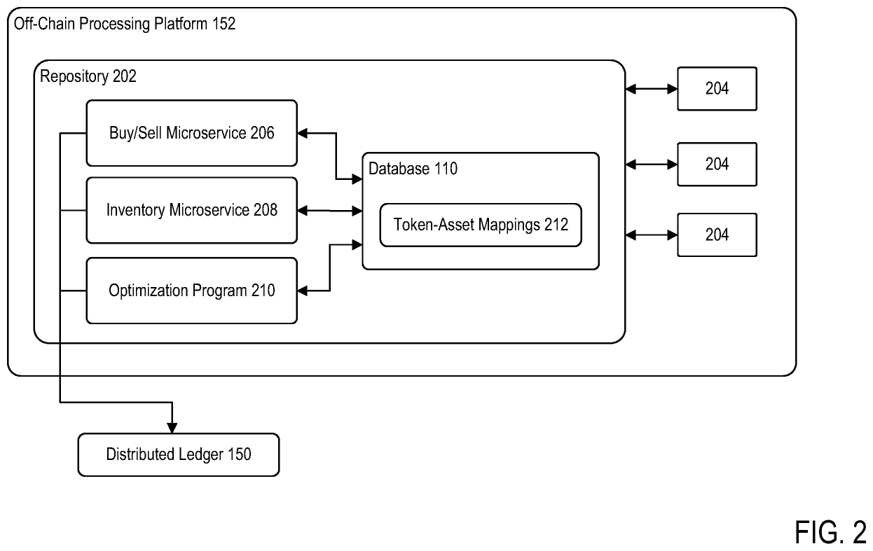

FIG. 2 is a block diagram illustrating off-chain processing platform 152, according to example embodiments. As shown, off-chain processing platform 152 may include repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least transaction microservice 206, inventory microservice 208, and optimization program 210. In some embodiments, repository 202 may include database 110. However, as those skilled in the art understand, database 110 may be hosted separate from off-chain processing platform 152.

Each of transaction microservice 206, inventory microservice 208, and optimization program 210 may be comprised one or more software modules. The one or more software modules are collections of code or instructions stored on a media that represent a series of machine instructions (e.g., program code) that implements one or more algorithmic steps. Such machine instructions may be the actual computer code the processor interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Transaction microservice 206 may be configured to track and record transactions to be broadcast to distributed ledger 150. In some embodiments, transaction microservice 206 may track the issuance or assignment of new digital tokens to client nodes 102. For example, when an issuer node 104 issues a new digital token to a client node 102, transaction microservice 206 may record the new digital token, the assignment of the digital token to the client node 102 (e.g., wallet address), and the mapping between the new digital token and the physical asset to which the new digital token is backed. In some embodiments, transaction microservice 206 may track the burning or redemption of digital tokens. For example, when a given digital token is burned or redeemed by client node 102, transaction microservice 206 may record the burning or redeeming of the digital token. In some embodiments, transaction microservice 206 may track transactions by monitoring activity between client nodes 102. For example, if a first client node 102 is attempting to transact with a second client node 102, transaction microservice 206 may record the transaction. Essentially, transaction microservice 206 may be configured to maintain database 110 of ownership of digital tokens, mapping of digital tokens to physical assets, and transactions involving digital tokens between client nodes.

Inventory microservice 208 may be configured to source inventory of physical assets. In some embodiments, inventory microservice 208 may be configured to source inventory of physical assets from existing centralized or distributed inventory management systems. For example, inventory microservice 208 may utilize one or more application programming interfaces (APIs) to monitor or retrieve data from existing centralized or distributed inventory management systems.

Optimization program 210 may be configured to optimize the allocation of physical assets to digital assets. Optimization program 210 may optimize the allocation of physical assets to digital assets based on an objective defined by a developer, administrator, or user. In some embodiments, optimization program 210 may optimize the allocation of physical assets to digital assets to minimize fragmentation. For example, optimization program 210 may be configured to perform one or more defragmentation techniques to the assignment or allocation of physical assets to digital assets, such that the minimum possible number of physical assets may be utilized in backing the overall digital tokens issued on distributed ledger 150. In some embodiments, optimization program 210 may optimize the allocation of physical assets to digital assets in a manner that minimizes disruptions to clients holding the digital assets. More generally, optimization program 210 may be customized to achieve various optimization targets set by the developer, administrator, or user.

In some embodiments, optimization program 210 may be configured to switch between a set of pre-defined optimization algorithms, depending on the specific digital token products utilized in distributed ledger 150.

In some embodiments, the pre-defined optimization algorithms may include an optimization algorithm that minimizes the number of physical assets needed for backing digital tokens. Such optimization algorithm may be used when, for example, the physical assets are fungible tokens.

In some embodiments, the pre-defined optimization algorithms may include an optimization algorithm that minimizes the number of accounts affected by the off-chain optimization of digital tokens to physical assets.

In some embodiments, the pre-defined optimization algorithms may include an optimization algorithm that minimizes the number of times an account may be affected by the off-chain optimization of digital tokens to physical assets.

In some embodiments, the pre-defined optimization algorithms may include an optimization algorithm that takes into account the rules of different jurisdictions.

In some embodiments, the pre-defined optimization algorithms may include an optimization algorithm that takes into account the preferences of its token holders. For example, a token holder may set a preference that only whole gold bars back their digital tokens.

In some embodiments, optimization program 210 may be configured to execute the optimization process at scheduled periods. For example, optimization program 210 may be configured to execute the optimization process at end of day to ensure that all transactions between client nodes are properly settled. In some embodiments, optimization program 210 may be configured to execute one or more optimization processes on-demand.

As indicated above, each digital token issued on distributed ledger 150 may be backed by a physical asset. In some embodiments, when issuer node 104 issues a new digital token, issuer node 104 may back the digital token with a fractional share of a physical asset. For example, each gold bar may a weight and quality associated with it. When used to back a digital token, traditionally, issuer node 104 would assign a fractional share of the gold bar to the digital token based on the gold bar's weight and quality. Such mapping (e.g., token-asset mapping 212) is stored in a database, such as database 110.

To improve upon this process, optimization program 210 may receive, at the scheduled or on-demand time, a plurality of inputs to determine how to best allocate physical assets to digital tokens in a manner that minimizes the number of physical assets required. For example, optimization program 210 may receive, as input: a list of transactions for the day, a previous position for the day (e.g., a snapshot of the digital tokens prior to settlement of the list of transactions for the day), and a current inventory of physical assets. Based on these inputs, optimization program 210 may optimize the manner in which the physical assets are assigned to digital tokens. For example, rather than utilize fractional shares from three distinct gold bars to back three distinct tokens, optimization program 210 can re-allocate the fractional shares to a single gold bar based on the weight and quality associated with the three distinct gold bars. In this manner, rather than utilize, for example, an eighth fractional share of three distinct gold bars, optimization program 210 may re-allocate the fractional shares to a single gold bar. In this manner, optimization program 210 may defragment the assignment of physical assets to digital assets.

Optimization program 210 may store the allocation of physical assets to digital assets in database 110. Continuing with the above example, each gold bar may have an identifier associated therewith. A given user may have the following allocation:
Token #1 mapped to one-eighth share of gold bar ABC
Token #2 mapped to one-third share of gold bar BCA
Token #3 mapped to one-tenth share of gold bar CBA

Once optimized, optimization program 210 may settle the transactions between client nodes 102 and/or between issuer nodes 104 and client nodes 102 by broadcasting the transactions to distributed ledger 150. In some embodiments, optimization program 210 may broadcast the mapping of physical assets to digital assets (e.g., token-asset mappings 212) to distributed ledger 150.

As indicated above, In some embodiments, off-chain processing platform 152 may operate without database 110. In such embodiments, off-chain processing platform 152 may determine token-asset mappings 212 and broadcast those token-asset mappings 212 directly to distributed ledger 150, without storing an off-chain copy.

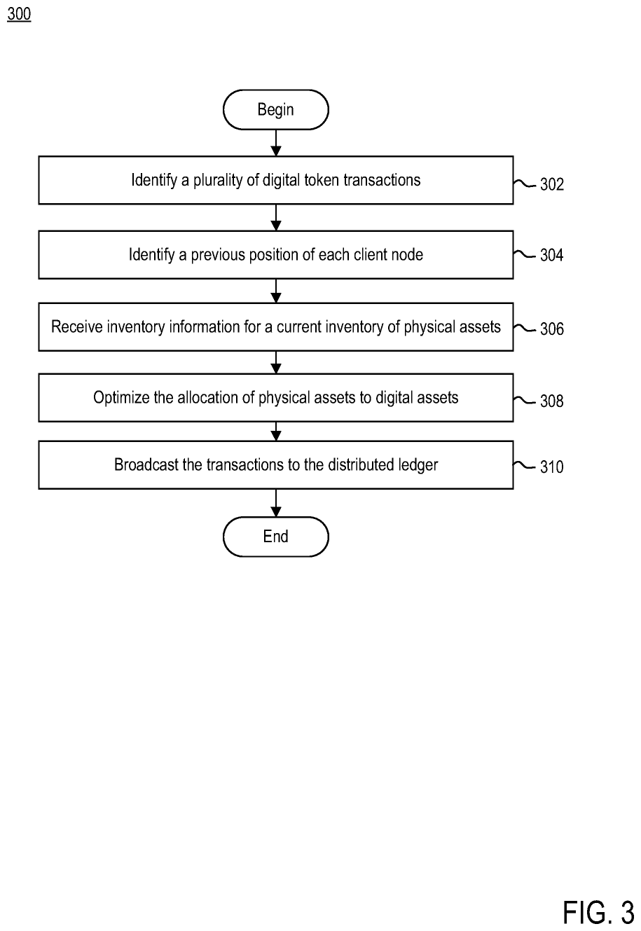

FIG. 3 is a flow diagram illustrating a method 300 of defragmenting an assignment of physical assets to digital assets, according to example embodiments. Method 300 may begin at step 302.

At step 302, off-chain processing platform 152 may identify a plurality of digital token transactions. For example, transaction microservice 206 may track the issuance or assignment of new digital tokens to client nodes 102, the burning or redemption of digital tokens, and the buying/selling of digital tokens between client nodes. In some embodiments, transaction microservice 206 may track transactions by monitoring activity between client nodes 102. Transaction microservice 206 may provide the plurality of digital token transactions as input to optimization program 210.

At step 304, off-chain processing platform 152 may identify a previous position of each client node. For example, off-chain processing platform 152 may receive from transaction microservice 206 a snapshot of the digital tokens prior to the current day's settlement. In some embodiments, the snapshot may be a snapshot of database 110. For example, as discussed above, database 110 may store the mapping of physical assets to digital tokens, ownership of digital tokens, and transactions between client nodes. As such, a snapshot of database 110 may represent a previous position of participants to distributed ledger 150 prior to settling the current batch of transactions identified in step 302.

At step 306, off-chain processing platform 152 may receive inventory information for a current inventory of physical assets. For example, inventory microservice 208 may source inventory of physical assets from existing centralized or distributed inventory management systems. For example, inventory microservice 208 may utilize one or more application programming interfaces (APIs) to monitor or retrieve data from existing centralized or distributed inventory management systems. Inventory microservice 208 may provide the current inventory of physical assets to optimization program 210 as input.

At step 308, off-chain processing platform 152 may optimize the allocation of physical assets to digital assets based on the plurality of digital token transactions, the previous position of each client node, and the current inventory information of physical assets. For example, based on the plurality of transactions for the day, a previous position for the day (e.g., a snapshot of the digital tokens prior to settlement of the list of transactions for the day), and a current inventory of physical assets, optimization program 210 may optimize the allocation of physical assets to digital assets to minimize the number of physical assets utilized, minimize the number of accounts affected, minimize the number of times an account is affected, or the like. Such process may result in the defragmentation of physical assets.

In some embodiments, optimization program 210 may optimize the allocation of physical assets based on the type of physical asset backing the digital assets. For example, optimization program 210 may select a first optimization algorithm corresponding to a first physical asset (e.g., real estate). In another example, optimization program 210 may select a second optimization algorithm corresponding to a second physical asset (e.g., gold bars).

In some embodiments, optimization program may optimize the allocation of physical assets based on a specified business need. For example, optimization program 210 may optimize the allocation of physical assets based on an optimization target specified by an entity associated with private networked computers 108 and/or issuer nodes 104.

In some embodiments, optimization program 210 may optimize the allocation of physical assets to digital tokens based on a type of digital token. For example, as indicated above, digital tokens may take two forms: a fungible token or a non-fungible token. For fungible tokens, optimization program 210 may allocate equal shares of physical assets to each digital token (e.g., each digital token is worth an eighth of a standard gold bar). For non-fungible tokens, optimization program 210 may allocate unequal shares of physical assets to each digital token, depending on the amount specified by the non-fungible token. For example, a first user may have a first non-fungible token valued at three-eighths of a gold bar, while a second user may have a second non-fungible token valued at two-eighths of a gold bar.

At step 310, off-chain processing platform 152 may settle the plurality of digital token transactions. For example, once the allocation of physical assets to digital assets are optimized, off-chain processing platform 152 may broadcast or write the plurality of transactions to distributed ledger 150. In some embodiments, off-chain processing platform 152 may broadcast or write the mapping of physical assets to digital assets to distributed ledger 150, as well. Such process may trigger a synchronization process of distributed ledger 150 across all distributed instances, such that each instance of distributed ledger 150 is updated with the plurality of transactions and/or the updating mapping of physical assets to digital assets.

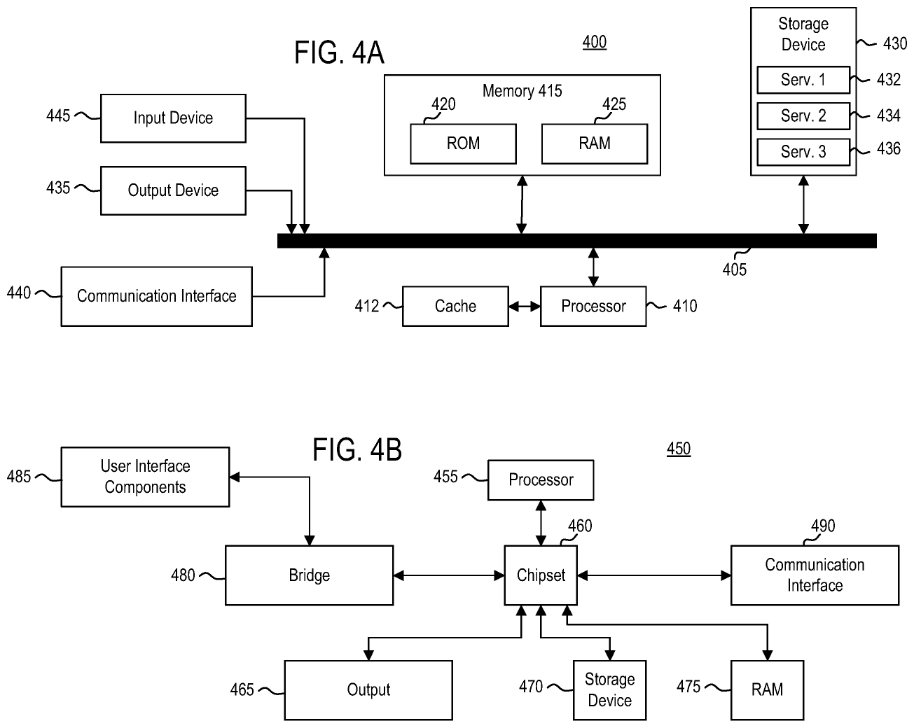

FIG. 4A illustrates an architecture of system bus computing system 400, according to example embodiments. One or more components of system 400 may be in electrical communication with each other using a bus 405. System 400 may include a processor (e.g., one or more CPUs, GPUs or other types of processors) 410 and a system bus 405 that couples various system components including the system memory 415, such as read only memory (ROM) 420 and random access memory (RAM) 425, to processor 410. System 400 can include a cache of high-speed memory connected directly with, in close proximity to, or integrated as part of processor 410. System 400 can copy data from memory 415 and/or storage device 430 to cache 412 for quick access by processor 410. In this way, cache 412 may provide a performance boost that avoids processor 410 delays while waiting for data. These and other modules can control or be configured to control processor 410 to perform various actions. Other system memory 415 may be available for use as well. Memory 415 may include multiple different types of memory with different performance characteristics. Processor 410 may be representative of a single processor or multiple processors. Processor 410 can include one or more of a general purpose processor or a hardware module or software module, such as service 1 432, service 2 434, and service 4 436 stored in storage device 430, configured to control processor 410, as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction with the system 400, an input device 445 which can be any number of input mechanisms, such as a microphone for speech, a touch-sensitive screen for gesture or graphical input, keyboard, mouse, motion input, speech and so forth. An output device 435 (e.g., a display) can also be one or more of a number of output mechanisms known to those of skill in the art. In some instances, multimodal systems can enable a user to provide multiple types of input to communicate with system 400. Communications interface 440 can generally govern and manage the user input and system output. There is no restriction on operating on any particular hardware arrangement and therefore the basic features here may easily be substituted for improved hardware or firmware arrangements as they are developed.

Storage device 430 may be a non-volatile memory and can be a hard disk or other types of computer readable media that can store data that are accessible by a computer, such as magnetic cassettes, flash memory cards, solid state memory devices, digital versatile disks, cartridges, random access memories (RAMs) 425, read only memory (ROM) 420, and hybrids thereof.

Storage device 430 can include services 432, 434, and 436 for controlling the processor 410. Other hardware or software modules are contemplated. Storage device 430 can be connected to system bus 405. In one aspect, a hardware module that performs a particular function can include the software component stored in a computer-readable medium in connection with the necessary hardware components, such as processor 410, bus 405, output device 435 (e.g., a display), and so forth, to carry out the function.

FIG. 4B illustrates a computer system 450 having a chipset architecture, according to example embodiments. Computer system 450 may be an example of computer hardware, software, and firmware that can be used to implement the disclosed technology. System 450 can include one or more processors 455, representative of any number of physically and/or logically distinct resources capable of executing software, firmware, and hardware configured to perform identified computations. One or more processors 455 can communicate with a chipset 460 that can control input to and output from one or more processors 455. In this example, chipset 460 outputs information to output 465, such as a display, and can read and write information to storage device 470, which can include magnetic media, and solid-state media, for example. Chipset 460 can also read data from and write data to storage device 475 (e.g., RAM). A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 455 analyzing data stored in storage device 470 or 475. Further, the machine can receive inputs from a user through user interface components 485 and execute appropriate functions, such as browsing functions by interpreting these inputs using one or more processors 455.

It can be appreciated that example systems 400 and 450 can have more than one processor 410 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by a computing system, a plurality of transactions in a decentralized computing environment involving digital tokens backed by physical assets, the plurality of transactions spanning a first time period;
identifying, by the computing system, a previous position of the decentralized computing environment by capturing a snapshot of token ownership and physical asset to digital token allocation during a period immediately preceding the first time period;
identifying, by the computing system, inventory information corresponding to the physical assets backing the digital tokens;
defragmenting, by the computing system, an allocation of physical assets to digital tokens based on the plurality of transactions, the previous position of the decentralized computing environment, and the inventory information corresponding to the physical assets; and
following the defragmenting, broadcasting, by the computing system, the plurality of transactions to a distributed ledger of the decentralized computing environment.

2. The method of claim 1, further comprising:
causing, by the computing system, the distributed ledger to synchronize across distributed computer systems hosting the distributed ledger in the decentralized computing environment.

3. The method of claim 1, wherein defragmenting, by the computing system, the allocation of the physical assets to the digital tokens minimizes a number of physical assets utilized to back to the digital tokens.

4. The method of claim 1, wherein defragmenting, by the computing system, the allocation of the physical assets to the digital tokens comprises:
identifying a type of physical asset utilized in the decentralized computing environment; and
defragmenting the allocation of the physical assets to the digital tokens based on the type of physical asset.

5. The method of claim 1, wherein defragmenting, by the computing system, the allocation of the physical assets to the digital tokens comprises:
determining that the digital tokens comprise non-fungible tokens; and
defragmenting the allocation of the physical assets to the non-fungible tokens in accordance with a physical asset share assigned to each non-fungible token.

6. The method of claim 1, wherein broadcasting, by the computing system, the plurality of transactions to the distributed ledger of the decentralized computing environment comprises:
settling the plurality of transactions between client nodes of the distributed ledger.

7. The method of claim 1, further comprising:
identifying an optimization algorithm according to an optimization objective associated with the computing system; and
defragmenting the allocation of the physical assets to the digital tokens based on the optimization algorithm.

8. A non-transitory computer readable medium comprising one or more sequences of instructions, which, when executed by a processor, causes a computing system to perform operations comprising:
receiving, by the computing system, a plurality of transactions in a decentralized computing environment involving digital tokens backed by physical assets, the plurality of transactions spanning a first time period;
identifying, by the computing system, a previous position of the decentralized computing environment by capturing a snapshot of token ownership and physical asset to digital token allocation during a period immediately preceding the first time period;
identifying, by the computing system, inventory information corresponding to the physical assets backing the digital tokens;
defragmenting, by the computing system, an allocation of physical assets to digital tokens based on the plurality of transactions, the previous position of the decentralized computing environment, and the inventory information corresponding to the physical assets; and
following the defragmenting, broadcasting, by the computing system, the plurality of transactions to a distributed ledger of the decentralized computing environment.

9. The non-transitory computer readable medium of claim 8, further comprising:
causing, by the computing system, the distributed ledger to synchronize across distributed computer systems hosting the distributed ledger in the decentralized computing environment.

10. The non-transitory computer readable medium of claim 8, wherein defragmenting, by the computing system, the allocation of the physical assets to the digital tokens minimizes a number of physical assets utilized to back to the digital tokens.

11. The non-transitory computer readable medium of claim 8, wherein defragmenting, by the computing system, the allocation of the physical assets to the digital tokens comprises:
identifying a type of physical asset utilized in the decentralized computing environment; and
defragmenting the allocation of the physical assets to the digital tokens based on the type of physical asset.

12. The non-transitory computer readable medium of claim 8, wherein defragmenting, by the computing system, the allocation of the physical assets to the digital tokens comprises:
determining that the digital tokens comprise non-fungible tokens; and
defragmenting the allocation of the physical assets to the non-fungible tokens in accordance with a physical asset share assigned to each non-fungible token.

13. The non-transitory computer readable medium of claim 8, wherein broadcasting, by the computing system, the plurality of transactions to the distributed ledger of the decentralized computing environment comprises:
settling the plurality of transactions between client nodes of the distributed ledger.

14. The non-transitory computer readable medium of claim 8, further comprising:
identifying an optimization algorithm according to an optimization objective associated with the computing system; and
defragmenting the allocation of the physical assets to the digital tokens based on the optimization algorithm.

15. A system comprising:
a processor; and
a memory having programming instructions stored thereon, which, when executed by the processor, causes the system to perform operations comprising:
receiving a plurality of transactions in a decentralized computing environment involving digital tokens backed by physical assets, the plurality of transactions spanning a first time period;
identifying a previous position of the decentralized computing environment by capturing a snapshot of token ownership and physical asset to digital token allocation during a period immediately preceding the first time period;
identifying inventory information corresponding to the physical assets backing the digital tokens;
defragmenting an allocation of physical assets to digital tokens based on the plurality of transactions, the previous position of the decentralized computing environment, and the inventory information corresponding to the physical assets; and
following the defragmenting, broadcasting the plurality of transactions to a distributed ledger of the decentralized computing environment.

16. The system of claim 15, wherein the operations further comprise:
causing the distributed ledger to synchronize across distributed computer systems hosting the distributed ledger in the decentralized computing environment.

17. The system of claim 15, wherein defragmenting the allocation of the physical assets to the digital tokens minimizes a number of physical assets utilized to back to the digital tokens.

18. The system of claim 15, wherein defragmenting the allocation of the physical assets to the digital tokens comprises:
identifying a type of physical asset utilized in the decentralized computing environment; and
defragmenting the allocation of the physical assets to the digital tokens based on the type of physical asset.

19. The system of claim 15, wherein defragmenting the allocation of the physical assets to the digital tokens comprises:
determining that the digital tokens comprise non-fungible tokens; and
defragmenting the allocation of the physical assets to the non-fungible tokens in accordance with a physical asset share assigned to each non-fungible token.

20. The system of claim 15, wherein broadcasting the plurality of transactions to the distributed ledger of the decentralized computing environment comprises:
settling the plurality of transactions between client nodes of the distributed ledger.
